(19) United States
(12) Patent Application Publication
(10) Pub. No.: US 2003/0140128 A1
(43) Pub. Date: Jul. 24, 2003

(54) System and method for validating a network

(75) Inventors: Robert Vincent Cox, Austin, TX (US); Stephanos Solonos Heracleous, Austin, TX (US); Clayton H. Walther, Austin, TX (US)

Correspondence Address: Baker Botts L.L.P., One Shell Plaza, 910 Louisiana, Houston, TX, 77002-4995, US

(73) Assignee: Dell Products L.P., Round Rock, TX (US)

(21) Appl. No.: 10/051,682

(22) Filed: Jan. 18, 2002

(51) Int. Cl. G06F 15/177

(52) U.S. Cl. 709/221; 717/171

(57) ABSTRACT

An information handling system validates a network configuration. The information handling system includes a network interface in communication with a network of devices. The information handling system also includes a predefined set of valid device attributes, stored in a computer-usable medium. In addition, the information handling system includes processing resources in communication with the network interface and the computer-usable medium. The processing resources receive user input requesting a validation process and, in response, automatically communicate with the devices via the network interface to discover attributes of the devices. The processing resources also automatically compare the discovered attributes with the predefined set of valid device attributes, and the processing resources generate output data that indicates whether the discovered attributes match the valid device attributes. For example, the output data may identify an invalid attribute among the discovered attributes and a corresponding valid attribute from the predefined set of valid device attributes.

### TECHNICAL FIELD

The present disclosure relates in general to computer networks. In particular, this disclosure relates to a system and a method for validating distributed information handling systems, such as storage area networks, local area networks (LANs), wide area networks (WANs), or other kinds of enterprise computing systems.

### BACKGROUND

A computer network allow the computers and other devices in the network to share resources. For example, a central file server may provide a common data repository for multiple hosts. Many different types of hardware and software may be combined to make many different kinds of networks. However, to operate properly, the hardware and software components in any particular network must generally be compatible with one another. For example, enterprise computing systems such as storage area networks (SANs) can involve very complex topologies, and users may experience problems if certain aspects of the SAN hardware and software configurations do not have the proper characteristics. For instance, problems may be experienced if the devices themselves, or the software components in the devices, are not at the levels or revisions which are expected for proper interoperation.

Currently, a network administrator typically validates whether or not a network is properly configured by referring to documentation that provides interconnection rules for the various pieces of hardware and software in the network. Furthermore, the network may include many different kinds of components, and the network administrator may need to piece together the interconnection rules from multiple sources (e.g., from different reference manuals for each different kind of component). Once compiled, the interconnection rules should specify the approved characteristics for the various pieces of hardware. The interconnection rules should also specify the required characteristics for the software, such as the required revision levels for the various applications, drivers, and firmware. In addition, the network administrator may need to manually inspect or poll various components of the network to retrieve the characteristics of those components, for comparison with the interconnection rules.

In complex networks, network validation is therefore frequently very time consuming, labor intensive, and prone to inaccuracies or errors. As recognized by the present invention, a need therefore exists for improved means for validating networks.

### SUMMARY

The present disclosure relates to a system, a method, and software for validating a network configuration. For example, an information handling system includes a network interface in communication with a network of devices. The information handling system also includes a predefined set of valid device attributes, stored in a computer-usable medium. In addition, the information handling system includes processing resources in communication with the network interface and the computer-usable medium. The processing resources receive user input requesting a validation process and, in response, automatically communicate with the devices via the network interface to discover attributes of the devices. The processing resources also automatically compare the discovered attributes with the predefined set of valid device attributes, and the processing resources generate output data that indicates whether the discovered attributes match the valid device attributes. For example, the output data may identify an invalid attribute among the discovered attributes and a corresponding valid attribute from the predefined set of valid device attributes.

The system can be used to test the validity of a fully connected, live network, such as a storage area network, a local area network, a wide area network, or other kinds of enterprise computing systems. Since the system automatically tests network validity, the amount of time and labor required to validate the network may be significantly reduced, and the reliability of the results may be significantly increased, relative to manual methods for validating networks.

Various embodiments may also include additional features. For example, an embodiment may use different control logic modules to discover attributes of different types of devices, and those modules may be easily updated. Another embodiment may facilitate updates to the predefined set of valid device attributes.

### BRIEF DESCRIPTION OF THE DRAWINGS

The present disclosure and its numerous objects, features, and advantages may be better understood by reference to the following description of an example embodiment and the accompanying drawings, in which:

FIG. 1 presents a block diagram of an example storage area network;

FIG. 2 is a block diagram of a host from the example storage area network of FIG. 1;

FIG. 3 is a block diagram depicting an example network validation system according to the present invention;

FIGS. 4A and 4B present a flowchart of an example process for validating a network;

FIG. 5 depicts an example predefined set of valid device attributes for use in performing network validation; and

FIG. 6 depicts example component validation modules for use in performing network validation.

### DETAILED DESCRIPTION OF AN EXAMPLE EMBODIMENT

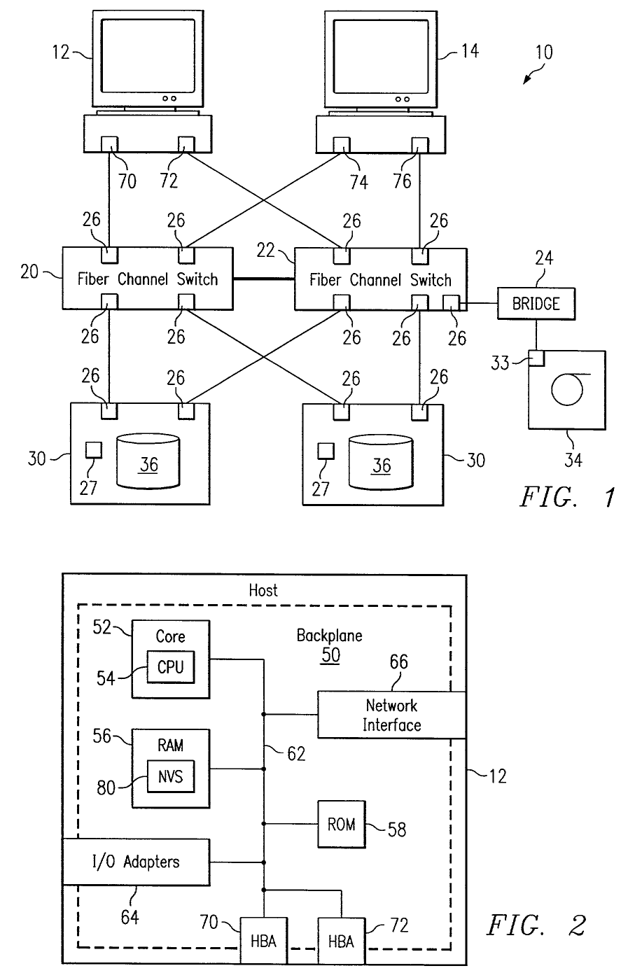

The present invention relates to a system, a method, and software for validating a network configuration. Referring now to FIG. 1, for purposes of illustration, this disclosure uses an example information handling system 12 in an example network 10 to illustrate various aspects of the invention and various additional or alternative features of the invention. Specifically, the example embodiment relates to an implementation of the invention adapted to validate a storage area network (SAN) 10. SAN 10 includes information handling system 12, and, as shown in FIG. 2, a network validation system (NVS) 80 resides at least partially on information handling system 12. Information handling system 12 may also be referred to as host 12, and SAN 10 may also be referred to generally as a distributed information handling system 10. In particular, NVS 80 is designed to confirm the validity of a fully connected, live network by directly communicating with the various network devices that have been assembled to confirm proper interconnection, software installation, and overall functioning of the network.

As illustrated, SAN 10 includes two or more hosts 12 and 14 interconnected with two or more storage enclosures 30, via two or more fiber channel switches 20 and 22. Specifically, host 12 includes two host bus adapters (HBAs) 70 and 72, and each HBA is connected to a port 26 on a different fiber channel switch via a fiber channel connection. Likewise, host 14 includes HBAs 74 and 76, which connect host 14 with fiber channel switches 20 and 22, respectively. The multiple connections provide for uninterrupted service in case any single HBA or fiber channel switch were to fail over. Fiber channel switches 20 and 22 also provide connectivity to more than one storage enclosure 30, as illustrated. Each storage enclosure includes a storage processor 32 and one or more disk drives 36. SAN 10 also includes a tape drive 34, which is accessed via a fiber-channel-to-SCSI bridge 24 and a SCSI port 33.

With reference now to FIG. 2, host 12 includes a backplane 50 with one or more system buses 62 interconnecting various system components such as a processing core 52 with one or more central processing units (CPUs) 54, random access memory (RAM) 56, and read only memory (ROM) 58. NVS 80 may reside at least partially in RAM 56. Host 12 may also include I/O adapters 64 for sending output to and receiving input from devices such as a keyboard, a mouse, and a display. Host 12 also includes various network interfaces in communication with processing core 52, including Ethernet interface 66 for communicating with a local area network, as well as HBAs 70 and 72 for communicating with other devices in SAN 10. The various hardware and software components of host 12 may be referred to collectively as processing resources.

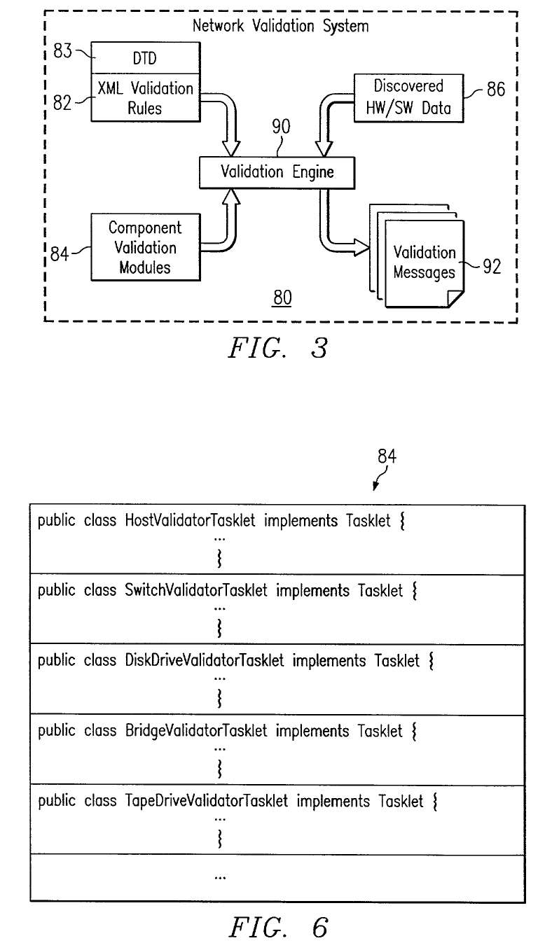

Referring now to FIG. 3, the example NVS 80 is illustrated in greater detail. NVS 80 includes a predefined set of valid device attributes, and that set of attributes is encoded using a markup language such as extensible markup language (XML), as illustrated by XML validation rules 82. This approach to encoding validation rules allows NVS 80 to be easily updateable with the latest validation rules.

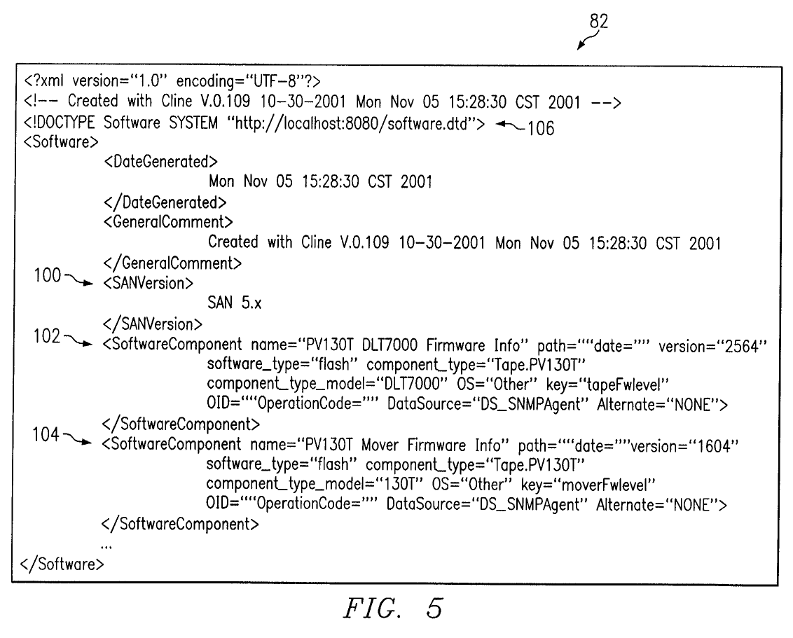

With reference to FIG. 5, XML validation rules 82 include numerous different XML elements 102 and 104, and each element lists the attributes that are known to be valid for a specific type of network device or a specific component of a network device. As shown in FIG. 3, NVS 80 also includes a document type definition (DTD) 83 which specifies the valid XML elements that may be included in XML validation rules 82. Element 106 in FIG. 5 depicts a reference to DTD 83.

The predefined set of valid device attributes corresponds to various components that are known to be interoperable. For example, XML elements 102 and 103 relate to one particular type of tape drive. XML element 102 lists the valid attributes for one particular firmware module in that tape drive, and XML element 104 provides the valid attributes for a different firmware module in that tape drive. In particular, XML elements 102 and 104 specify the respective revision level for each firmware module that is known to be valid for the tape drive to inter-operate with other devices in a network. The revision level may also be referred to as the software version.

In the example embodiment, XML validation rules 82 also list a particular identifier for the overall set of valid attributes, as illustrated at XML element 100. Specifically, in the example embodiment, devices with attributes from the set of predefined valid attributes are tested prior to the release of XML validation rules 82 to verify specifically which types of devices and which software versions will effectively operate with each other. Accordingly, FIG. 5 depicts a particular set of valid device attributes identified collectively as SAN version 5.x, as shown at element 100.

As network technology changes and different devices become available, a provider of network equipment or network administration services may then test a new set of devices and list the known good attributes for the new set in a new file of XML validation rules collectively identified as SAN version 6.x, for example.

NVS 80 also includes a set of component validation modules 84 and a validation engine 90 which uses component validation modules 84 to directly communicate with and obtain device attributes from the various network devices in SAN 10. Specifically, as illustrated in FIG. 6, component validation modules 84 provide a number of different, dynamically loadable control logic modules for communicating with different types of devices. In the example embodiment, those modules are known as tasklets. A tasklet is a small program that is called to perform a specific unit of work. The tasklets may be written in the programming language distributed under the JAVA trademark, for instance, and different tasklets may be designed to communicate with different types of network devices. For example, one tasklet may be used to communicate with hosts, another may be used to communicate with switches, a third may be used to communicate with disk drives, etc.

Once the actual device attributes are received from the network devices, validation engine 90 compares the discovered hardware and software data 86 with the known good attributes from XML validation rules 82 to determine whether the current network configuration is valid. Validation engine 90 then produces output data for users such as network administrators. Specifically, the output data, which is illustrated as validation messages 92, indicate whether the network configuration is valid. In addition, for devices that are not valid, validation messages 92 include a description of the invalid attributes together with the attributes that would be valid. For example, if validation engine 90 determines that fiber channel switch 20 has firmware with a revision level that does not match the valid revision level listed in XML validation rules 82, validation engine 90 may display both the discovered, invalid revision level and the valid revision level.

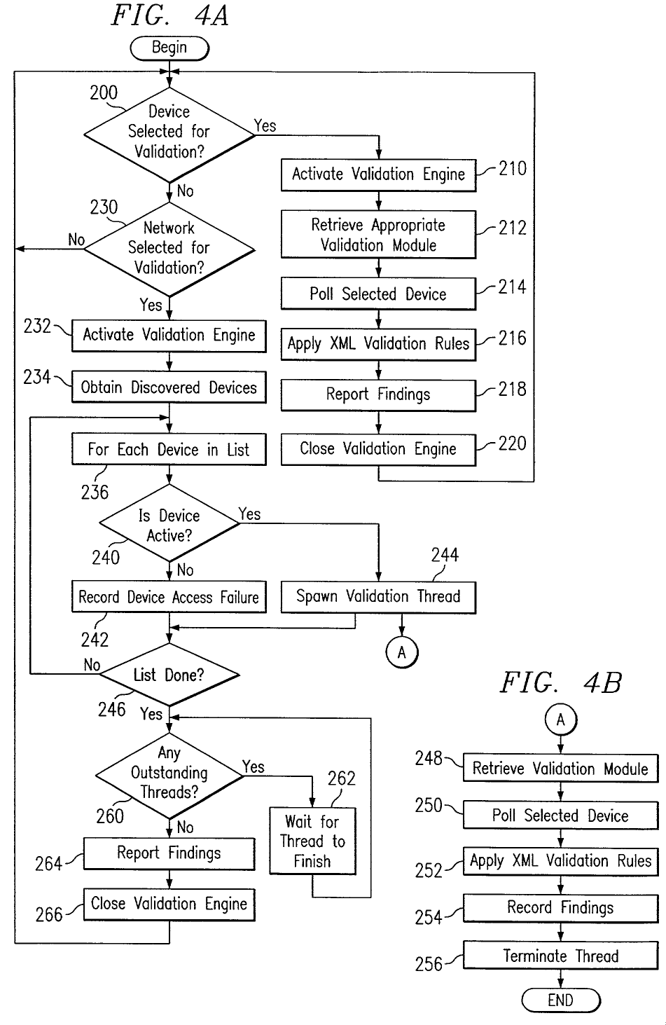

Referring now to FIG. 4A, a flowchart is used to describe an example process for validating network configuration in SAN 10. That process begins with the devices in SAN 10 interconnected as illustrated in FIG. 1 and with NVS 80 executing in host 12. NVS 80 then determines whether a user has entered input selecting a particular network device for validation, as depicted at block 200. If the user has selected a particular network device for validation, NVS 80 activates validation engine 90, as indicated at block 210. Validation engine 90 then loads the appropriate validation module from component validation modules 84, as shown at block 212. For example, if the selected device is a switch, validation engine 90 retrieves or loads a component validation module that is designed to communicate with switches.

As depicted at block 214, the component validation module is then used to retrieve the device attributes from the selected device. In the example embodiment, component validation modules 84 include simple network management protocol (SNMP) data retrieval models, and NVS 80 is Internet enabled and can communicate with an enterprise-level network configuration design engine, such as DELLSTAR. The SNMP modules collect management information from the various SAN components in a live SAN to assist in proper SAN validation.

That management information may include software attributes, as well as hardware attributes. For example, if polling a switch, a component validation module may retrieve a revision level for one or more firmware modules in the switch, as well as data indicating which ports in the switch are connect to other devices. Other kinds of attributes that component validation modules 84 can discover include device driver versions, operating system version, and software application versions.

Validation engine 90 then applies XML validation rules 82 to the discovered attribute data to determine whether the device has valid attributes, as shown at block 216. For example, validation engine 90 may compare a firmware revision level discovered on a device with a known good revision level for that firmware.

As indicated at block 218, validation engine 90 then produces one or more corresponding validation messages 92 to provide data for the user indicating whether the discovered device attributes are valid. NVS 80 then closes validation engine 90 and awaits further user input, as indicated by block 220 and the arrow returning to block 200 from block 220.

However, if a particular device was not selected for validation, the process passes from block 200 to block 230. Block 230 illustrates NVS 80 determining whether NVS 80 has received user input selecting an option for validating the network as a whole. If the user has not requested validation for the network as a whole, NVS 80 continues to wait for user input requesting validation, as indicated by the arrow returning to block 200 from block 230. However, if it is determined at block 230 that the user has selected overall network validation, the process passes to block 232, which illustrates NVS 80 activating validation engine 90. As depicted at block 234, validation engine 90 then obtains a list of discovered devices residing in network 10. For instance, the list may be obtained using a ping/SNMP sweep methodology, in which a user pre-configures IP addresses for devices in the network and validation engine 90 uses those pre-configured addresses to locate devices. Alternatively, validation engine 90 may obtain the device list from a separate application, such as third party storage management software. As indicated at blocks 236 and 240, after obtaining the list of discovered devices, validation engine 90 determines, for each device in the list, whether the device is active, for example by pinging an IP address associated with that device.

If a device is inactive, validation engine 90 records device access failure, as depicted at block 242. If the device is active, validation engine 90 spawns a validation thread for the device, as shown at block 244. After recording the failure or spawning a validation thread, validation engine 90 determines whether all of the devices in the list have been tested for active status, as indicated at block 246. If any devices remain to be tested, the process returns to block 236. Validation engine 90 may thus spawn multiple threads for multiple validation modules; this multithreading helps complete network validation in a shorter amount of time.

FIG. 4B depicts the operations that are performed by each of the spawned validation threads. Specifically, after a thread is spawned in block 244 of FIG. 4A, the illustrated flow of execution passes through page connector A to block 248 of FIG. 4B. As depicted at blocks 248 and 250, each validation thread retrieves an appropriate validation module, based on the type of device for which the thread was spawned, and that module is used to retrieve the device attributes from the device. Validation engine 90 then applies XML validation rules 82 to the hardware and software data discovered from the device, as described above, and records the findings with regard to validity, as indicated at blocks 252 and 254. The thread is then terminated, as shown at block 256.

Referring again to FIG. 4A, as indicated at block 260, after threads have been spawned for all devices, validation engine 90 determines whether any of those validation threads are still outstanding. If so, validation engine 90 waits for all outstanding validation threads to terminate, as indicated at block 262 and the arrow returning to block 260 from block 262. Once all outstanding threads have finished executing, the process passes from block 260 to block 264, which illustrates validation engine 90 producing validation messages 92 to report the findings with regard to the validity of each device in network 10. As indicated at block 266, NVS 80 then closes validation engine 90. As indicated by the arrow returning to block 200, NVS 80 then awaits user input requesting further network validation.

However, within the validation process, validation engine 90 may also determine whether SAN 10 conforms to specific hardware interconnect rules. For example, there may be a limit to the number of servers that are supported in a network. Alternatively, certain hardware components may not operate correctly when used in the same network. A network may also be constrained with respect to cable types (e.g., optical vs. copper) for certain interconnections, network zoning, and connection restrictions (e.g., either policy or physical limits). These are all examples of some different types of hardware interconnect rules that may be included in XML validation rules 82 and verified by validation engine 90 to determine whether SAN 10, or a specific device or connection in SAN 10, is valid.

It should also be noted that, in the example embodiment, NVS 80 uses three levels of caching, with caching at the database level, a middle-tier in-memory cache, and a client cache, to improve online performance. The caching subsystem returns validation information to validation engine 90 when a request for validation data is performed. The client cache is implemented at a client console (not expressly illustrated), which provides an interface between a user and validation engine 90. For instance, the client console may communicate with validation engine 90 via network connection 66. When validation data is needed, if a request for the same validation data was performed within a predetermined amount of time (which is configurable), the console will not formally request validation data but will use the data that it has in memory.

If the validation data that the console has in memory has aged over the predetermined amount of time, then the data is stale and the console sends a request to validation engine 90 to get a refresh of the validation data. Since validation engine 90 may serve multiple clients, its copy of the data may be newer than the data kept at the client console. If the validation data has not aged beyond a predetermined amount of time, then validation engine 90 returns a copy of its data to the client.

If the validation data is not within the in-memory cache of validation engine 90, then a request to a database is performed to get the validation data. The validation data from the database is then stored in the database and returned to the client console. However, if the database does not have the requested validation data or the data in the database is stale, then a request to the actual device is performed to get new validation data. The data is then stored in the database and returned to the client console.

As will be evident from the above description, NVS 80 provides numerous advantages, relative to manual methods for validating networks. For example, NVS 80 may validate a network more rapidly, more accurately, and with less human labor. In addition, NVS 80 or various components thereof may be easily updated or modified to validate different sets of known-valid device combination in many different kinds of distributed information handling systems. In addition, a new set of validation rules may be all that is required to update or enhance the functionality of validation engine 90. The new rules may be adopted by simply refreshing a computer file containing the validation rules, and the software tools such as validation engine 90 need not be re-tested and re-released. Additionally, XML validation rules 82 may be used to produce catalogs for marketing purposes. Vendors and customers may therefore be assured that the catalogs describe network components that are known to work together effectively.

Although the present invention has been described with reference to an example embodiment, those with ordinary skill in the art will understand that numerous variations of the example embodiment could be practiced without departing from the scope and spirit of the present invention. For example, the hardware and software components depicted in the example embodiment represent functional elements that are reasonably self-contained so that each can be designed, constructed, or updated substantially independently of the others. In alternative embodiments, however, it should be understood that the components may be implemented as hardware, software, or combinations of hardware and software for providing the functionality described and illustrated herein. In alternative embodiments, information handling systems incorporating the invention may include personal computers, mini computers, mainframe computers, distributed computing systems, and other suitable devices. Additionally, in alternative embodiments, some of the components of the NVS could reside on different data processing systems, or all of the components could reside on the same hardware.

Alternative embodiments of the invention also include computer-usable media encoding logic such as computer instructions for performing the operations of the invention. Such computer-usable media may include, without limitation, storage media such as floppy disks, hard disks, CD-ROMs, read-only memory, and random access memory; as well as communications media such wires, optical fibers, microwaves, radio waves, and other electromagnetic or optical carriers. The control logic may also be referred to as a program product.

Many other aspects of the example embodiment may also be changed in alternative embodiments without departing from the scope and spirit of the invention. The scope of the invention is therefore not limited to the particulars of the illustrated embodiments or implementations but is defined by the appended claims.

What is claimed is:

1. A method of validating a network, the method comprising:
receiving user input requesting a validation process;
in response to the user input, automatically discovering attributes of devices in the network;
automatically comparing the discovered attributes with a predefined set of valid device attributes; and
generating output data that indicates whether the discovered attributes match the valid device attributes.

2. The method of claim 1, wherein the operation of generating output data comprises:
generating output data that identifies an invalid attribute among the discovered attributes and a corresponding valid attribute from the predefined set of valid device attributes.

3. The method of claim 1, wherein:
the predefined set of valid device attributes specifies valid software versions;
the operation of automatically discovering attributes of the devices comprises automatically discovering version information for software in one or more of the devices; and
the operation of automatically comparing the discovered attributes with the predefined set of valid device attributes comprises automatically comparing the discovered version information with the valid software versions.

4. The method of claim 3, wherein:
the software in at least one of the one or more devices comprises firmware; and
the operation of automatically comparing the discovered attributes with the predefined set of valid device attributes comprises automatically determining whether the firmware has a valid version.

5. The method of claim 1, wherein the operation of automatically discovering attributes of the devices comprises:
automatically identifying a device type for at least one of the devices;
dynamically loading a validation module based on the identified device type; and
automatically using the validation module to poll the at least one device.

6. The method of claim 1, further comprising:
automatically determining the valid device attributes by reference to a file that uses a markup language to encode the valid device attributes.

7. The method of claim 6, wherein:
the file with the valid device attributes comprises an extensible markup language (XML) file; and
the operation of automatically determining the valid device attributes comprises parsing the XML file by reference to a document type definition (DTD) file, wherein the DTD file contains definitions of data elements for validating the network.

8. A program product for validating devices in a network, the program product comprising:
a computer-usable medium; and
computer instructions encoded in the computer-usable medium, wherein, when executed, the computer instructions perform operations comprising:
receiving user input requesting a validation process;
in response to the user input, automatically discovering attributes of devices in the network;
automatically comparing the discovered attributes with a predefined set of valid device attributes; and
generating output data that indicates whether the discovered attributes match the valid device attributes.

9. The program product of claim 8, wherein the operation of generating output data comprises:
generating output data that identifies an invalid attribute among the discovered attributes and a corresponding valid attribute from the predefined set of valid device attributes.

10. The program product of claim 8, wherein:
the predefined set of valid device attributes specifies valid software versions;
the operation of automatically discovering attributes of the devices comprises automatically discovering version information for software in one or more of the devices; and
the operation of automatically comparing the discovered attributes with the predefined set of valid device attributes comprises automatically comparing the discovered version information with the valid software versions.

11. The program product of claim 10, wherein:
the software in at least one of the one or more devices comprises firmware; and
the operation of automatically comparing the discovered attributes with the predefined set of valid device attributes comprises automatically determining whether the firmware has a valid version.

12. The program product of claim 8, wherein the operation of automatically discovering attributes of the devices comprises:
automatically identifying a device type for at least one of the devices;
dynamically loading a validation module based on the identified device type; and
automatically using the validation module to poll the at least one device.

13. The program product of claim 8, wherein the computer instructions perform further operations comprising:
automatically determining the valid device attributes by reference to a file that uses a markup language to encode the valid device attributes.

14. An information handling system for validating a network configuration, the information handling system comprising:
a computer-usable medium;
a predefined set of valid device attributes stored in the computer-usable medium;
a network interface in communication with a network of devices; and
processing resources in communication with the network interface and the computer-usable medium, wherein the processing resources perform operations comprising:
receiving user input requesting a validation process;
in response to the user input, automatically communicating with the devices via the network interface to discover attributes of the devices;
automatically comparing the discovered attributes with the predefined set of valid device attributes; and
generating output data that indicates whether the discovered attributes match the valid device attributes.

15. The information handling system of claim 14, wherein the processing resources generate output data that identifies an invalid attribute among the discovered attributes and a corresponding valid attribute from the predefined set of valid device attributes.

16. The information handling system of claim 14, wherein:
the predefined set of valid device attributes specifies valid software versions;
the processing resources automatically discover version information for software in one or more of the devices; and
the processing resources automatically compare the discovered version information with the valid software versions.

17. The information handling system of claim 16, wherein the software in at least one of the one or more devices comprises firmware, and the processing resources automatically determine whether the firmware has a valid version.

18. The information handling system of claim 14, wherein:
the processing resources automatically identify a device type for at least one of the devices;
the processing resources dynamically load a validation module based on the identified device type; and
the processing resources automatically use the validation module to poll the at least one device.

19. The information handling system of claim 14, further comprising:
a file that uses a markup language to encode the valid device attributes, wherein the processing resources automatically determine the valid device attributes by reference to the file with the valid device attributes.

20. The information handling system of claim 19, wherein:
the file with the valid device attributes comprises an extensible markup language (XML) file;
the information handling system further comprises a document type definition (DTD) file that contains definitions of data elements for validating the network; and
the processing resources automatically determine the valid device attributes by using the DTD file to parse the XML file.

21. The information handling system of claim 14, wherein the processing resources comprise:
one or more processors; and
software which, when executed by the one or more processors, cause the one or more processors to perform the operations of receiving user input, automatically communicating with the devices, automatically comparing the discovered attributes with the predefined set of valid device attributes, and generating output data.
